(19) United States
(12) Patent Application Publication
(10) Pub. No.: US 2007/0165511 A1
(43) Pub. Date: Jul. 19, 2007

(54) Signal processing method and optical pickup for keeping available information during high speed optical recording

(76) Inventors: Tse-Hsiang Hsu, Hsinchu (TW); Chia-Hua Chou, Hsintien City (TW)

Correspondence Address: HERSHKOVITZ & ASSOCIATES, 2845 DUKE STREET, ALEXANDRIA, VA, 22314, US

(21) Appl. No.: 11/331,206

(22) Filed: Jan. 13, 2006

(51) Int. Cl. G11B 7/00

(52) U.S. Cl. 369/124.12

(57) ABSTRACT

A signal processing method and an optical pickup are capable of reducing signal distortion. Before being transmitted over a flexible cable to an optical disk drive controller, a low-pass filtering process is performed over the light detection signals or their arithmetic results in the optical pickup to eliminate high frequency compositions of the signals. By this way, the interference resulting from the flexible cable during signal transmission is mitigated. The retained data in the signals are further applied to recover servo control signals. Therefore, the stability of an optical disk servo control is improved, especially for a high-speed optical disk system.

### BACKGROUND OF THE INVENTION

1. Field of the Invention

The present invention relates to a signal processing method and an optical pickup for reducing signal distortion, and particularly relates to a method and apparatus which can mitigate the signal distortion resulting from a signal transmission flexible cable.

2. Description of Related Art

With reference to FIG. 1, a conventional optical disk drive (ODD) architecture is composed of an optical pickup unit (12), an ODD controller (14), and a flexible cable (16) coupled between the optical pickup unit (12) and the ODD controller (14). The optical pickup unit (12) at least comprises a laser diode driver (LDD) (120), a laser diode (LD) (122), a splitter (124), an objective lens (126) and a photo detector (128). The ODD controller (14) includes a servo controller (142) and an analog pre-amplify unit (140) in which a sample and hold circuit (144) is implemented.

Based on the control of the LDD driver (120), the LD (122) can generate a laser beam irradiating on an optical disk (10) through the splitter (124) and the objective lens (126). The reflected laser beam from the optical disk (10) is received by the photo detector (128) and then converted into plural light detection signals as described hereinafter. The optical disk (10) is employed as a substrate material with a continuous spiral groove, which the player used to lock on to the track. The groove wobble means that the grooves wander back and forth with a fixed amplitude and special frequency. In the recording process, the groove wobble pattern could be detected as a sine wave that provides information such as recording address.

With reference to FIG. 2, the curves (27) on the optical disk (10) represent the wobble tracks. The photo detector (128) is composed of a main light receiving element (20) and two auxiliary light receiving elements (22)(24). The main light receiving element (20) can be divided into four light detection areas A, B, C and D, where areas A and D are situated on one side of an average centerline (28) of the track and the other areas B and C are situated on the other side.

Similarly, the first auxiliary light receiving element (22) with light detection areas E and F is located at one side of the average centerline (28) while the second auxiliary light receiving element (24) with light detection areas G and H is at the other side. Each of the aforementioned light detection areas A-H will produce and transmit a signal to a gain buffer (26) thus generating light detection signals S_{A}, S_{B}, S_{C}, S_{D}, S_{E}, S_{F}, S_{G} and S_{H}. Based on the eight light detection signals S_{A}-S_{H}, various kinds of signals such as a push pull signal, a tracking error signal, a focusing error signal and a radio frequency signal can be easily derived accordingly. These light detection signals can be further processed to generate one or more electrical signals.

These electrical signals are subsequently transmitted to the ODD controller (14) through the flexible cable (16). The analog pre-amplify unit (140) in association with the sample and hold circuit (144) retrieves desired information such as wobble information from the electrical signals to perform further signal processing. Based on the processing result, control signals required for optical disk operations are produced and provided to the servo controller (142).

For example, during the wobble information recovery process, the push pull signal S_{PP} is an essential signal and can be generated in accordance with S_{PP}=(S_{A}+S_{D})−(S_{B}+S_{C}). Based on the push pull signal S_{PP}, the wobble signal can then be recovered accordingly and obtain the physical address of the optical disk (10). The push pull signal S_{PP} can be derived by some feasible schemes.

1. The light detection signals S_{A}, S_{B}, S_{C} and S_{D} are firstly transmitted to the ODD controller (14) from the optical pickup unit (12) via the flexible cable (16). The light detection signals received by the ODD controller (14) are respectively denoted with S*_{A}, S*_{B}, S*_{C} and S*_{D} hereinafter for distinction. Upon the received light detection signals, the ODD controller (14) performs the operation S_{PP}=(S*_{A}+S*_{D})−(S*_{B}+S*_{C}) to derive the push pull signal S_{PP}.

2. The light detection signals S_{A} and S_{D} are added together by the optical pickup unit (12) to derive a composite signal S_{A} D (S_{A} D=S_{A} +S_{D}). The addition operation is also performed on the other two signals S_{B} and S_{C} to generate another composite signal S_{BC} (S_{BC}=S_{B}+S_{C}). The two composite signals S_{AD} and S_{BC} are subsequently transmitted to the ODD controller (14) via the flexible cable (16). Upon reception of the two composite signals, which are respectively denoted by S*_{AD} and S*_{BC}, the ODD controller (14) directly performs an operation S*_{AD}−S*_{BC} to derive the push pull signal S_{PP}.

When the optical disk drive performs a high-speed recording, because the power of the laser beam from the laser diode (122) is varied with data to be written, the output light detection signals of the photo detector (128), the push-pull signal generated based on the light detection signals, the tracking error signal, the focusing error signal and radio frequency signal all accordingly have the similar variation.

With reference to FIGS. 3A-3C, the light detection signal S_{A} output from the optical pickup unit (12) and the distorted light detection signal S*_{A} received by the ODD controller (14) are respectively illustrated. Since other light detection signals have the similar waveform as the signal S_{A}, they are accordingly omitted from the drawing. As mentioned above, the output signals of the optical pickup unit (12) are transmitted to the ODD controller (14) via the flexible cable (16), but for high speed transmission, the flexible cable (16) is unable to provide superior transmission quality.

In FIG. 3A, the ideal signal S_{A} mainly contains three levels as A-level, B-level, C-level levels. Signal S_{A} in these three levels all carries with information that is necessary for servo control. However, due to the slow slew rate of the flexible cable (16), the original signal S_{A} has been distorted after the transmission of the flexible cable (16) as shown in FIG. 3B. The slow slew rate signal drags a long transient period which is marked by broken lines-illustrated block in FIG. 3B. The carried information can not be retrieved in these periods. With reference to FIG. 3C, when the signal S_{A} is interfered with by the inductor effect or capacitor effect of the flexible cable (16), overshoot and undershoot problems will occur at the rising edges and falling edges in the transmitted signal S*_{A}.

For example, with reference to FIG. 4, an ideal arithmetic signal S_{B}−_{A} is able to offer all the required information based on the A, B, C levels for servo control. Contrary to FIG. 4, if the signals S_{A} and S_{B} are undesirably distorted due to the low slew rate of the flexible cable (16), the arithmetic signal S*_{B}−S*_{A} shown in FIG. 5 has almost become an unrecognizable signal for the ODD controller (14).

As the data recording speed of DVD disks increases, the distortion problem will significantly increase. In the worst situation, no stabilized light detection signal can be retrieved after the transmission of the flexible cable (16). The optical disk driver may thus have possible abnormal operation.

Therefore, the invention provides a novel method and apparatus for high speed optical storage device to mitigate or obviate the aforementioned problem.

### SUMMARY OF THE INVENTION

The main objective of the present invention is to provide a signal processing method and an optical pickup for reducing signal distortion, wherein the method and the apparatus are able to maintain high quality of light detection signals even when the optical disk drive performs high-speed data recording whereby the read/write periods of the apparatus are significantly shortened.

To accomplish the objective, the method performs a low-pass filtering process on the light detection signals or their composite signals before transmitting to an optical disk drive controller via a flexible cable.

Furthermore, the apparatus in accordance with the present invention comprises:

an optical pickup unit that has:
a laser diode driver generating a laser beam to irradiate on a track formed on an optical disk;
a photo detector that receives a reflected light beam from the optical disk and converts the reflected light signal into light detection signals; and
a controllable low-pass filter unit, which performs a low-pass filtering process over the light detection signals and is selectively disabled or enabled upon whether the optical disk drive system is performing data recording;

an optical disk drive (ODD) controller provided to control the optical pickup unit; and

at least one flexible cable coupled between the optical disk drive controller and the optical pickup unit for transmitting signals there between;

wherein the low-pass filtering process is performed prior to the light detection signals being transmitted to the ODD controller, thus a distortion of the signals caused from the flexible cable is mitigated.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a conventional optical disk driver;

FIG. 2 is an exemplary architecture schematic view of a conventional photo detector;

FIG. 3A is an exemplary waveform showing an ideal light detection signal S_{A} output from an optical pickup unit;

FIG. 3B is an exemplary waveform showing a distorted light detection signal S*_{A} received by an optical disk drive controller, wherein the signal distortion is resulted from the low slew rate of the flexible cable;

FIG. 3C is an exemplary waveform view showing another distorted light detection signal S*_{A} received by an optical disk drive controller, wherein the signal distortion is resulted from the inductor effect or capacitor effect of the flexible cable;

FIG. 4 shows exemplary waveforms of the ideal light detection signals S*_{A} and S*_{B} as well as their arithmetic signal S*_{B}−S*_{A};

FIG. 5 shows exemplary waveforms of the distorted light detection signals S*_{A} and S*B as well as their arithmetic signal S*B-S*_{A};

FIG. 6 is a block diagram of an optical disk drive according to an embodiment of the present invention;

FIG. 7 is a block diagram of an optical disk drive according to another embodiment of the present invention;

FIG. 8 shows the waveforms of multiple light detection signals output from a photo detector and a low-pass filtered signal;

FIG. 9 shows a block diagram of an optical disk drive according to another embodiment of the present invention; and

FIG. 10 shows the waveform of the processed light detection signal received by an ODD controller.

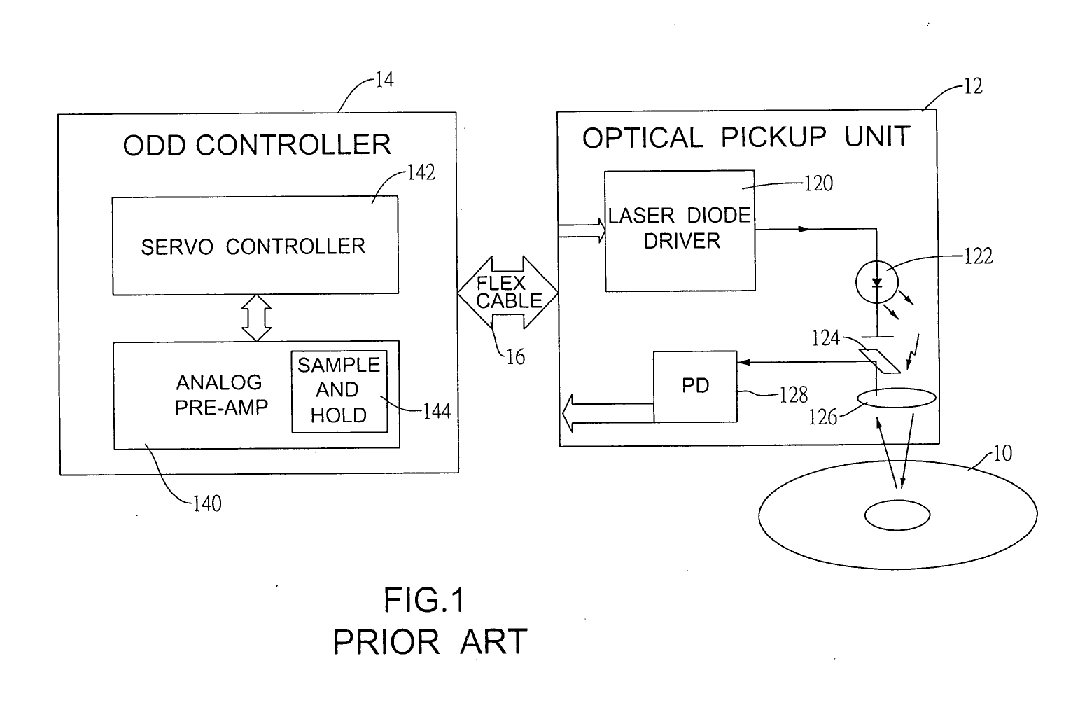

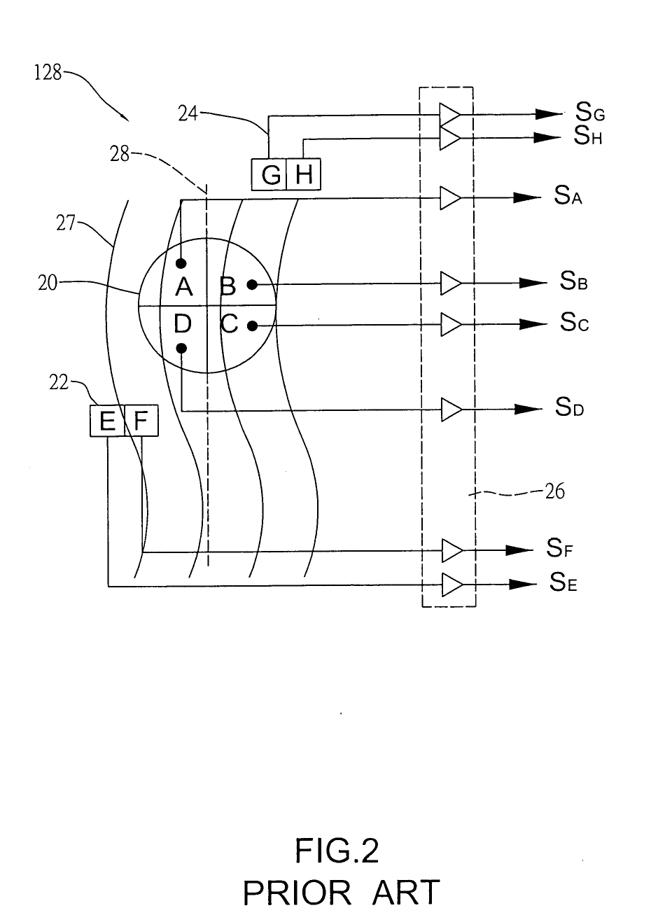

### DETAILED DESCRIPTION OF THE PREFERRED EMBODIMENT

In the present invention, a low-pass filtering process is performed over light detection signals or their composite signals before being transmitted to an ODD controller via a flexible cable. In order to prevent the high-frequency components distortion during transmission disturbs the desired information.

After the ODD controller receives these low-pass filtered light detection signals or their composite signals, the desired information is retained in these received signals. The desired information could be retrieved to produce control signals. The control signals may be a push pull signal, a tracking error signal, a focusing error signal, a radio frequency signal etc.

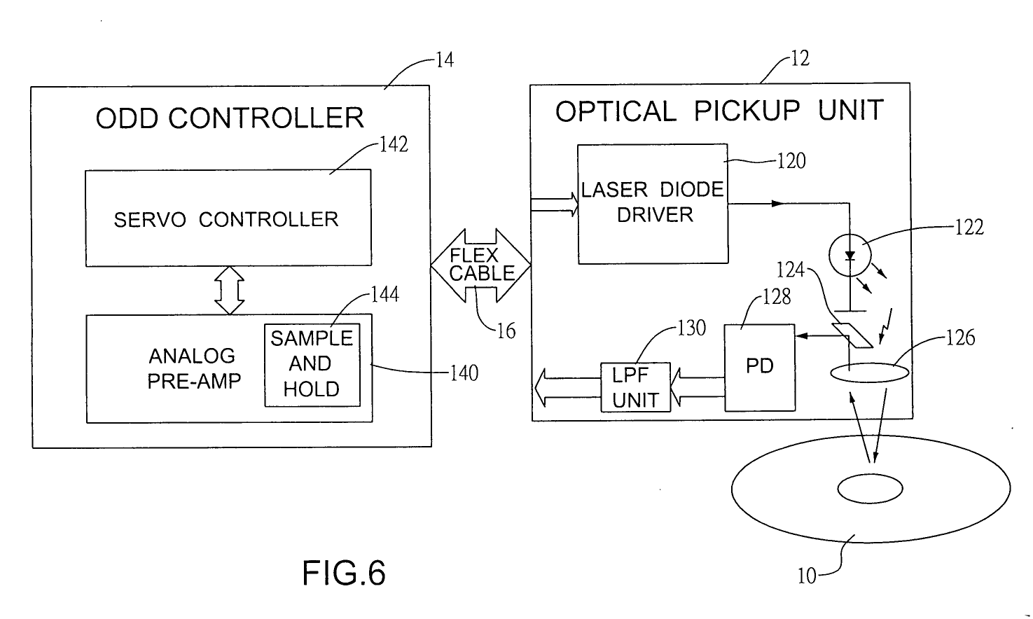

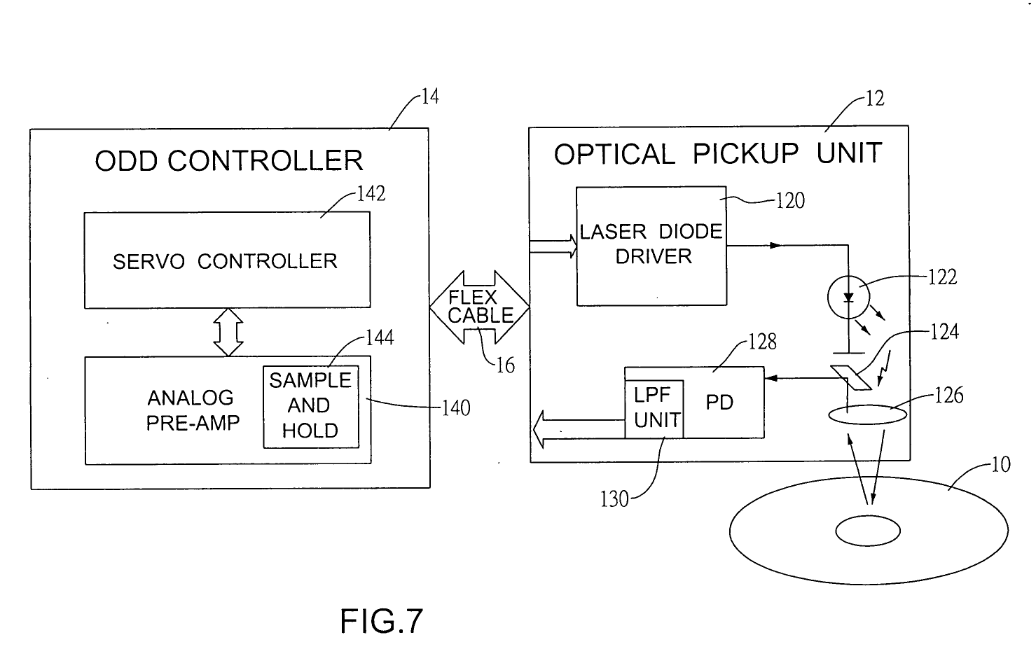

With reference to FIG. 6, an optical disk drive in accordance with a first embodiment of the present invention comprises an optical pickup unit (12) and an optical disk driver (ODD) controller (14) between which a flexible cable (16) is connected. The optical pickup unit (12) mainly has a laser diode driver (120), a laser diode (122), a splitter (124), an objective lens (126), a photo detector (128) and an independent controllable low-pass filter unit (LPF) (130). The ODD controller (14) includes a servo controller (142) and an analog pre-amplify unit (140). The second embodiment of the optical disk drive is illustrated in FIG. 7. The modification is the controllable LPF unit (130) has integrated with the photo detector (128).

As described above, the undesired effects resulting from the flexible cable causes significant distortion to the light detection signals from the photo detector. The distortion further causes the ODD controller (14) hard to extract the wobble information. To solve this problem, the controllable LPF unit (130) is applied to filter the light detection signals transmitted from the photo detector (128) to the ODD controller (14). With the completion of the processes of the LPF unit (130), high frequency component, contributed by the rapidly signal transition period such as the rising edges and falling edges of the light detection signals, has been eliminated. The remaining low frequency component can pass through the LPF unit (130) and be transmitted to the ODD controller (14) without being distorted by the high frequency components. Since the wobble information still retained in the low frequency components, the ODD controller (14) can recover the wobble information upon the received, low-pass filtered signals.

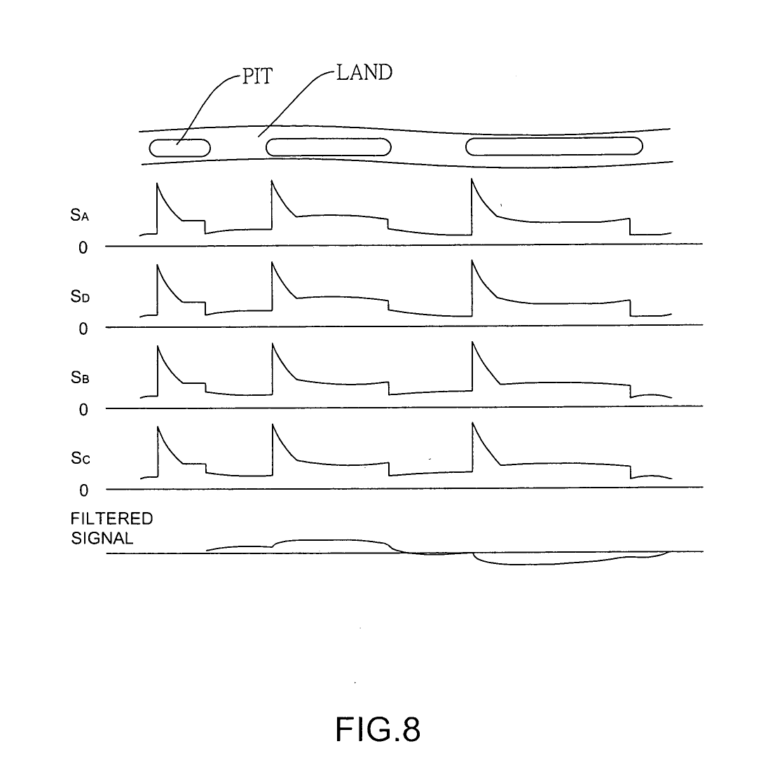

With reference to FIG. 8, shows a track of the optical disk (10). During recording, the optical pickup unit selectively forms part of the recording track to be marked pit area, with the other part of the track left as un-marked area. In the process of forming the marked pit area, the optical pick unit emits stronger light to the focusing area, the focusing area is being heated and turn into low-reflection marked pit. Because the emitted light is stronger, the reflected detection lights of S_{A}, S_{B}, S_{C} and S_{D} also become stronger in the beginning of the forming process. After while, when the low-reflection marked pit is formed, the reflected detection light becomes weaker then. Thus in this process, the detection light intensity shows a peak when crossing from the un-marked track area to the marked pit area. And vice versa, when crossing from the marked area into un-marked area, the emitted light shall be weaker. In FIG. 8, only one filtered signal, which the rapidly transition part has been removed, is depicted as an example for comparison with the non-processed signal.

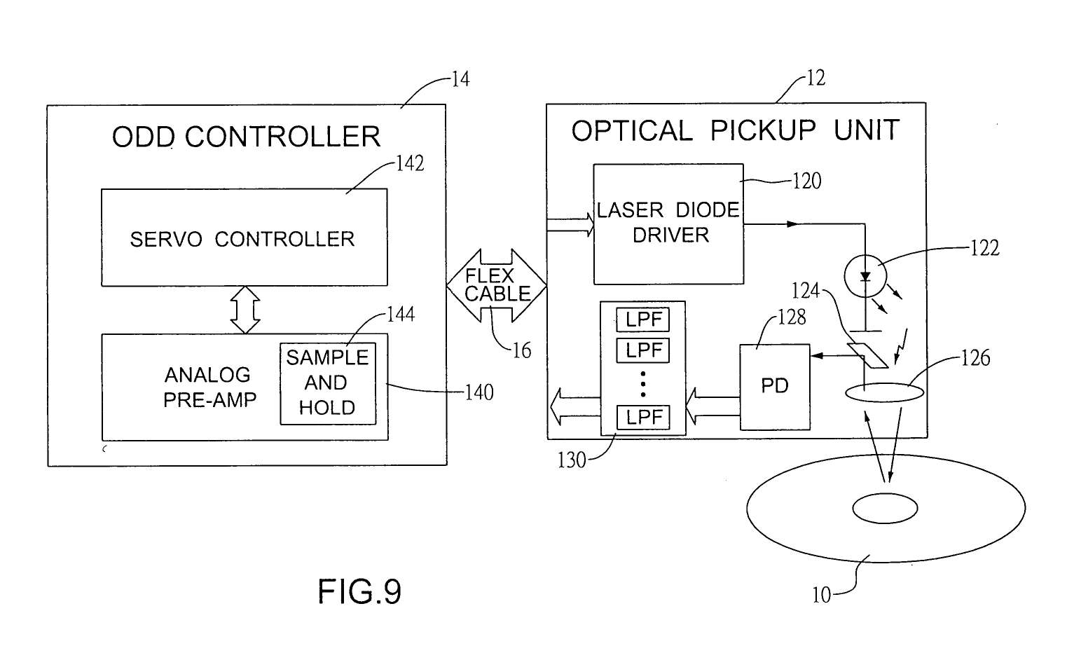

With reference to FIG. 9, the controllable LPF unit (130) can consist of multiple independent low-pass filters (132) to respectively process the light detection signals generated by the photo detector (128). It is noted that the filtering process can be performed over each of the light detection signals or their composite signal.

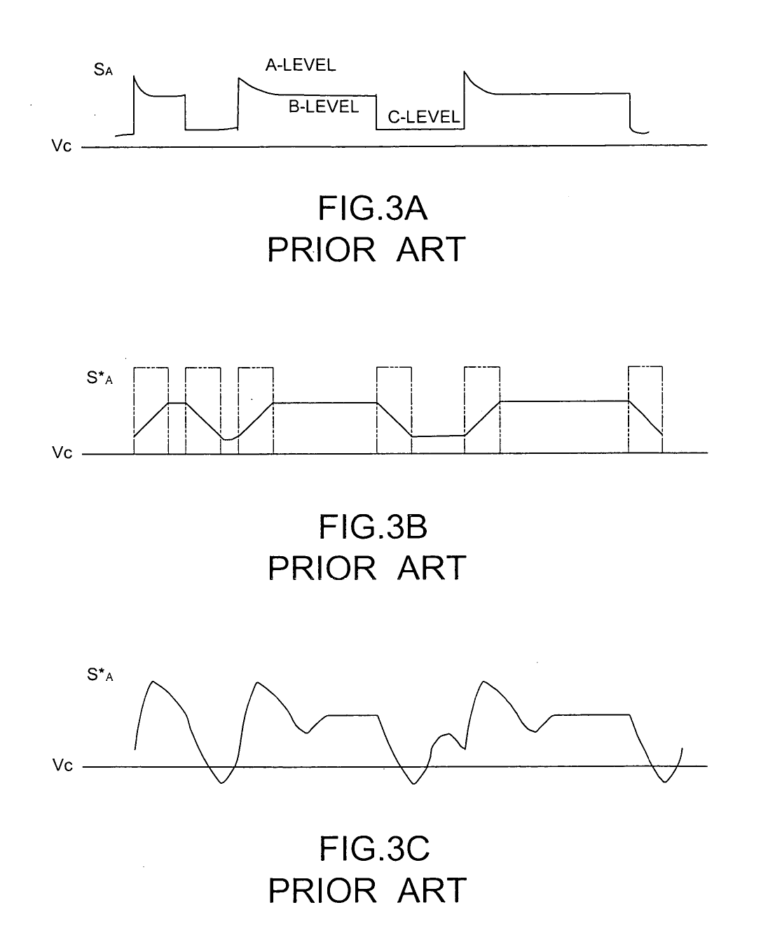

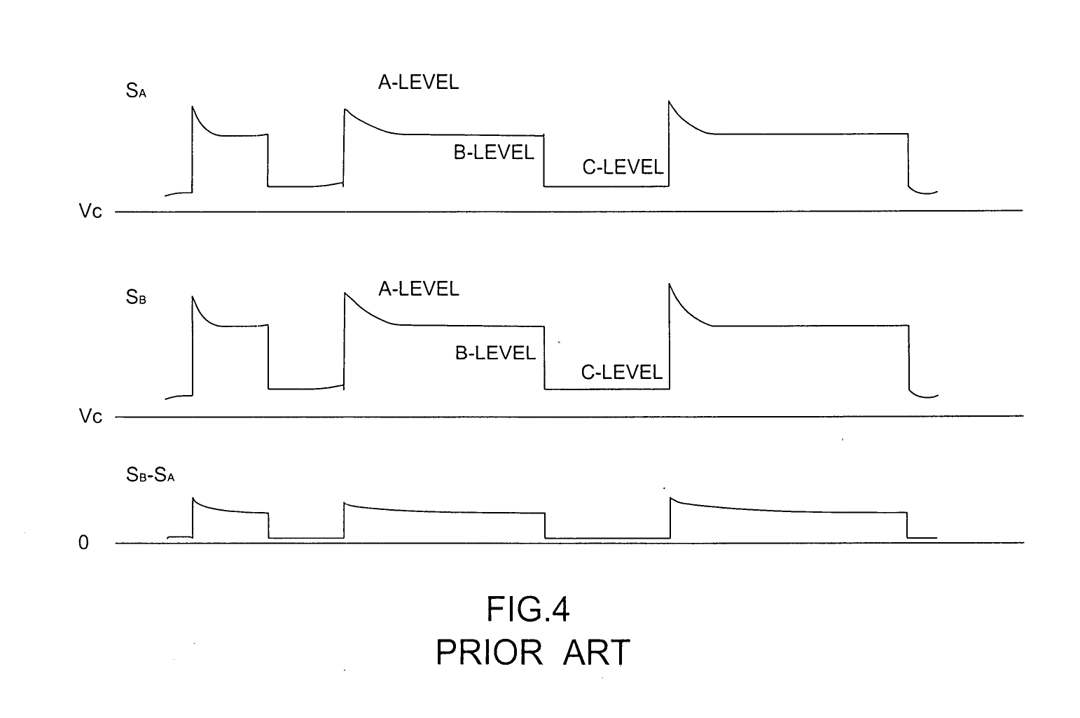

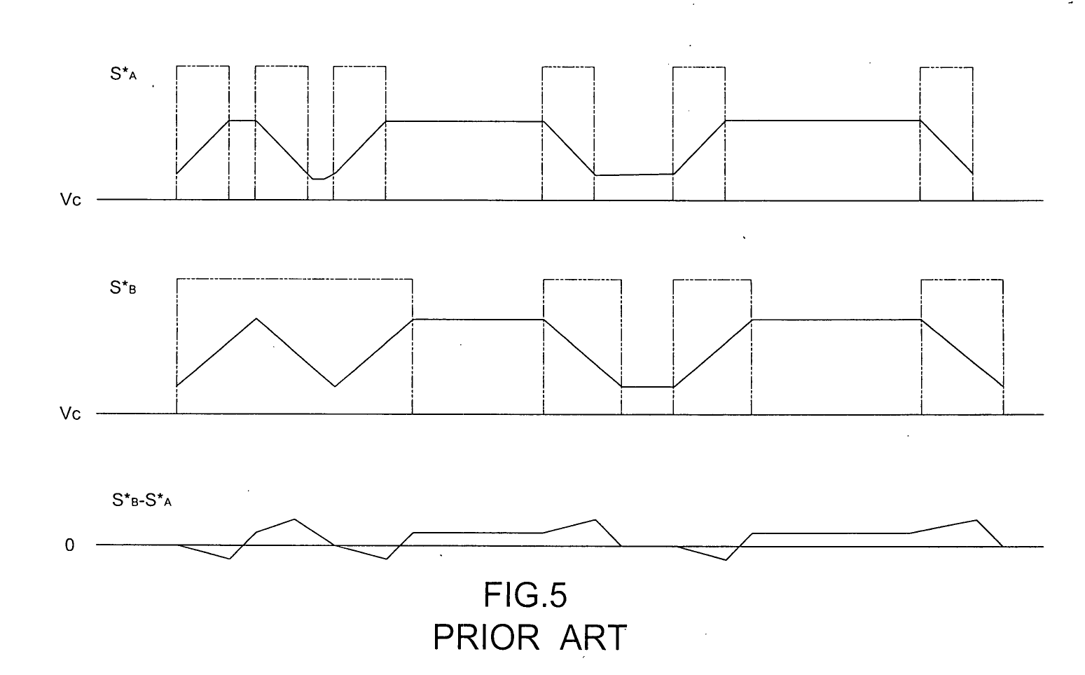

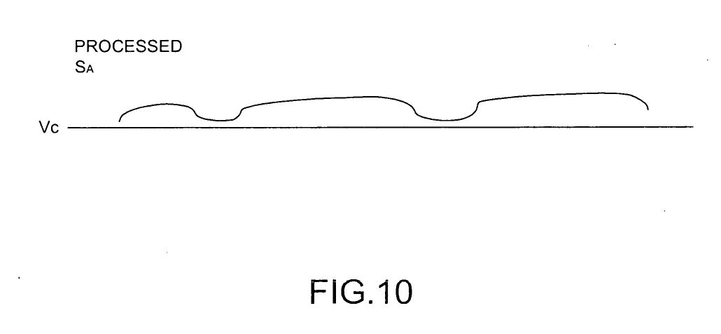

As depicted in FIG. 10, in comparison with the prior arts of FIGS. 3B and 3C, the light signal S_{A} processed by the LPF unit (130) is smoother than the light signal transmitted to the ODD controller (14) by the flexible cable (16). The detection light performed the filtering process in advance, will be more easily to retrieve the wobble information after transmitted to the ODD controller (14).

In order to avoid undesired interference, the LPF unit (130) must be purposely disabled when the optical disk drive is performing the data reading. In other words, the LPF unit (130) should only be activated during data recording processes. The enable/disable control signal for the LPF unit (130) can be supplied from either the ODD controller (14) or the laser diode driver (120). Furthermore, in response to different data recording speeds, the bandwidth of the LPF unit (130) is adjustable.

Through the foregoing description, the method in accordance with the present invention is to perform a filtering process over the light detection signals or their composite signals before the light detection signals are transmitted to the ODD controller (14) through the flexible cable (16).

The method can be concluded to the following steps:

receiving a light beam reflected from an optical disk and converting the received light beam into plural light detection signals, wherein the light detection signals can be further calculated to derive composite signals;

performing a low-pass filtering process over the light detection signals or their composite signals; and

transmitting the processed signals to an optical disk control device through a flexible cable.

In conclusion, while the optical disk drive is performing a data recording process on a CD/DVD, light detection signals or their composite signals are input to a low-pass filtering unit in advance to retrieve more available information before being sent to the ODD controller via the flexible cable. By the low-pass filtering process, the interference problem is able to be effectively mitigated after these light detection signals or their composite signals are delivered to the ODD controller. The light detection signals retain a high level of applicable information. Furthermore, superior quality of push-pull signals, servo control signals etc. can be derived to enhance the high speed recording process of the optical disk drive.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical disk drive system comprising:
an optical pickup unit that has:
a laser diode driver driving a laser diode to generate a laser beam to irradiate on a track formed on an optical disk;
a photo detector that receives a reflected light signal from the optical disk and converts the reflected light signal into light detection signals; and
a controllable low-pass filter unit, which performs a low-pass filtering process over the light detection signals and is selectively disabled or enabled upon whether the optical disk drive system is performing data recording;
an optical disk drive (ODD) controller provided to control the optical pickup unit; and
at least one flexible cable coupled between the optical disk drive controller and the optical pickup unit for transmitting signals there between;
wherein the low-pass filtering process is performed prior to the light detection signals being transmitted to the ODD controller, thus a distortion of the signals caused from the flexible cable is mitigated.

2. The optical disk drive system as claimed in claim 1, wherein a control signal is output from the ODD controller to disable or enable the controllable low-pass filter unit.

3. The optical disk drive system as claimed in claim 1, wherein a control signal is output from the laser diode driver controller to disable or enable the controllable low-pass filter unit.

4. The optical disk drive system as claimed in claim 2, wherein the control signal enables the low-pass filter unit while the optical disk drive system is performing the data recording, and disables the low-pass filter unit while the optical disk drive system is performing the data reading.

5. The optical disk drive system as claimed in claim 3 wherein the control signal enables the low-pass filter unit while the optical disk drive system is performing the data recording, and disables the low-pass filter unit while the optical disk drive system is performing the data reading.

6. The optical disk driver system as claimed in claim 1, wherein in response to different data recording speeds, a bandwidth of the low-pass filtering unit is accordingly varied.

7. The optical disk driver system as claimed in claim 4, wherein in response to different data recording speeds, a bandwidth of the low-pass filtering unit is accordingly varied.

8. The optical disk driver system as claimed in claim 5, wherein in response to different data recording speeds, a bandwidth of the low-pass filtering unit is accordingly varied.

9. The optical disk driver system as claimed in claim 1, wherein the low-pass filter unit has at least four low-pass filters that respectively process four light detection signals S_{A}, S_{B}, S_{C} and S_{D}.

10. The optical disk driver system as claimed in claim 1, wherein the low-pass filter unit has at least two low-pass filters that respectively process two composite signals S_{AD} and S_{BC} delivered from a calculation of the light detection signals.

11. The optical disk driver system as claimed in claim 9, wherein the low-pass filter unit further has four low-pass filters that respectively process four light detection signals S_{E}, S_{F}, S_{G} and S_{H}.

12. An optical pickup device having an output terminal coupled to an optical disk drive (ODD) controller via a flexible cable, the optical pickup device comprising:
an optical pickup unit that has:
a laser diode driver generating a laser beam to irradiate on a track formed on an optical disk;
a photo detector that receives a reflected light from the optical disk and converts the reflected light signal into light detection signals; and
a controllable low-pass filter unit, which performs a low-pass filtering process over the light detection signals and is selectively disabled or enabled upon whether the optical disk drive system is performing data recording;
wherein the low-pass filtering process is performed prior to the light detection signals being transmitted to the ODD controller, thus a distortion of the signals caused from the flexible cable is mitigated.

13. The optical pickup device claimed in claim 12, wherein a control signal is output from the ODD controller to disable or enable the controllable low-pass filter unit.

14. The optical pickup device as claimed in claim 12, wherein a control signal is output from the laser diode driver controller to disable or enable the controllable low-pass filter unit.

15. The optical pickup device as claimed in claim 13, wherein the control signal enables the low-pass filter unit while the optical disk drive system is performing the data recording, and disables the low-pass filter unit while the optical disk drive system is performing the data reading.

16. The optical pickup device as claimed in claim 14, wherein the control signal enables the low-pass filter unit while the optical disk drive system is performing the data recording, and disables the low-pass filter unit while the optical disk drive system is performing the data reading.

17. The optical pickup device as claimed in claim 12, wherein in response to different data recording speeds, a bandwidth of the low-pass filtering unit is accordingly varied.

18. The optical pickup device as claimed in claim 15, wherein in response to different data recording speeds, a bandwidth of the low-pass filtering unit is accordingly varied.

19. The optical pickup device as claimed in claim 16, wherein in response to different data recording speeds, a bandwidth of the low-pass filtering unit is accordingly varied.

20. The optical pickup device as claimed in claim 12, wherein the low-pass filter unit has at least four low-pass filters that respectively process four light detection signals S_{A}, S_{B}, S_{C} and S_{D}.

21. The optical disk driver system as claimed in claim 12, wherein the low-pass filter unit has at least two low-pass filters that respectively process two composite signals S_{AD} and S_{BC} delivered from a calculation of the light detection signals.

22. The optical disk driver system as claimed in claim 20, wherein the low-pass filter unit further has four low-pass filters that respectively process four light detection signals S_{E}, S_{F}, S_{G} and S_{H}.

23. A signal processing method of an optical pickup device, the method comprising the steps of:
receiving a light beam reflected from an optical disk and converting the received light beam into light detection signals, wherein the light detection signals can be further calculated to derive composite signals;
performing a low-pass filtering process over the light detection signals or their composite signals; and
transmitting the processed light detection signals to an optical disk control device through a flexible cable, wherein because the low-pass filtering process had been performed prior to the transmission of the light detection signals to the optical disk control device by the flexible cable, the distortion caused from the flexible cable is mitigated.
